(19) United States
(12) Patent Application Publication
(10) Pub. No.: US 2023/0286594 A1
(43) Pub. Date: Sep. 14, 2023

(54) VEHICLE INTERIOR FURNISHINGS AND RELATED ACCESSORIES AND FIXTURES

(71) Applicants: ROBERT CULPI, Santa Ana, CA (US); ERIK DURR, Dana Point, CA (US)

(72) Inventors: ROBERT CULPI, Santa Ana, CA (US); ERIK DURR, Dana Point, CA (US)

(21) Appl. No.: 18/182,860

(22) Filed: Mar. 13, 2023

Related U.S. Application Data
(60) Provisional application No. 63/319,148, filed on Mar. 11, 2022.

(51) Int. Cl. B62D 25/20; F16B 5/00; F16B 39/10

(52) U.S. Cl. CPC B62D 25/20; F16B 5/0044; F16B 39/108

(57) ABSTRACT

Disclosed are systems and methods for vehicle conversion projects. In one embodiment, disclosed are systems and methods for a flooring system, which can be used for installation in vehicle. In some embodiments, the flooring system includes flooring sections having matching tabs and notches that interlock. In certain embodiments, a clamping method uses bolts, nut inserts, and washers to clamp the flooring sections to each other. In one embodiment, the washers are configured and placed to overlap joints of the flooring sections. In some embodiments, floor brackets can be used to secure a flooring section to a fixed fixture of the vehicle. In one embodiment, the flooring sections are patterns cut into sheets of material and provided with retaining tabs to facilitate flat pack shipping of the flooring sections.

### RELATED APPLICATIONS

This application claims priority to provisional U.S. Patent Application No. 63/319,148 filed on Mar. 11, 2022, which is hereby incorporated herein in its entirety.

### FIELD

Embodiments of the invention relate generally to systems and methods for customizing vehicle interiors. In particular, embodiments of the invention are directed to various assemblies associated with vehicle furnishings such as beds, kitchens, cabinets, pantries, showers, toilets, water tanks, and the like.

### BACKGROUND

It is known to provide vehicle interior furnishing kits. Installation of such kits usually require drilling and complex cutting of materials to fit the interior contours of the vehicle. Some kits require permanent modification of the vehicle.

There is a need in the relevant technology for systems and methods that are removable and facilitate installation of vehicle interior furnishings without altering the vehicle. Furthermore there is a continuing need for systems and methods that facilitate quick installation of vehicle interiors by do-it-yourselfers. Embodiments of the invention disclosed here satisfy these and other needs.

### SUMMARY OF THE INVENTION

In one aspect, the invention is directed to a floor having a first floor section having a first side, the first side having alternating first tabs and first notches; a second floor section having a second side, the second side having alternating second tabs and second notches; wherein the first tabs are configured to interlock with the second notches, wherein the first notches are configured to interlock with the second tabs; a first bolt; a second bolt; a first bolt hole in the first floor section configured to receive the first bolt; a second bolt hole in the second floor section configured to receive the second bolt; a first insert configured to fit in the first bolt hole, the first insert further configured to receive the first bolt, the first insert having a first flange; a second insert configured to fit in the second bolt hole, the second insert further configured to receive the second bolt, the second insert having a second flange; a first washer retained between the first flange and the first floor section and the second floor section, wherein a surface of the first washer overlaps between the first floor section and the second floor section; and a second washer retained between the second flange and the first floor section and the second floor section, wherein a surface of the second washer overlaps between the first floor section and the second floor section.

In another aspect, the invention concerns a rod and bracket for hanging articles. In one embodiment, the rod and bracket can include a first bracket having a first locking slot, a second locking slot, and a first rotation space between the first locking slot and the second locking slot; a second bracket having a third locking slot, a fourth locking slot, and a second rotation space; a rod having a first arm, a second arm, and a hanging bar, wherein the first arm and the second arm are connected by the hanging bar, the hanging bar positioned substantially perpendicular to the first arm and to the second arm; wherein a distal end of the first arm is configured to fit into the first slot when the rod is in a closed position, wherein the distal end of the first arm is configured to fit into the second slot when the rod is in an open position, wherein the distal end of the first arm is configured to rotate in the first rotation space when the rod is rotated from the open position to the close position and vice versa; and wherein a distal end of the second arm is configured to fit into the third slot when the rod is in the closed position, wherein the distal end of the second arm is configured to fit into the fourth slot when the rod is in the open position, wherein the distal end of the second arm is configured to rotate in the second rotation space when the rod is rotated from the open position to the close position and vice versa.

In yet another aspect, the invention relates to a track and slide mechanism for a toilet. The mechanism having a tray configured to support the toilet; a slide coupled to the tray; a track coupled to a fixed support structure; and wherein the slide is configured to operatively couple to the track to facilitate alignment and overextension.

One aspect of the invention is directed to cabinetry assembly system having a first board comprising a plurality of tabs and t-shaped pockets alternating along a side of the first board; a nut space for receiving and retaining a nut, the nut space built into the t-shaped pocket; a second board comprising a plurality of tab pockets and bolt holes alternating along a side of the second board; wherein the tab pockets are configured to match and operatively couple to the tabs; wherein the bolt holes are configured to match the t-shaped pockets to facilitate the fastening of the first board to the second board by a tightening of the bolt into the nut.

Yet another aspect of the invention concerns an apparatus for supporting and folding away a tray. In one embodiment, the apparatus includes mounting arms for supporting the tray; moving arms operatively coupled to the mounting arms; fixed arms operatively coupled to the moving arms, the fixed arm configured to be attached to fixed support structure; wherein the fixed arms include a j-slot; wherein the moving arms include a sliding pin configured to fit into and slide on the j-slot; wherein the fixed arms include a first pivot point that operatively couple the fixed arms to the mounting arms; and wherein the moving arms include a second pivot point that operatively couple the fixed arms to the mounting arms.

One more aspect of the invention relates to an apparatus having a first board configured to span a width of the headliner of a van; a second boar stacked on the first board, the second board configured to span the width of the headliner of the van; a first bracket coupled to a first wall of the van; a second bracket coupled to a second wall of the van; wherein the first and second board are configured to be removably fastened to the first and second brackets.

One more aspect of the invention is directed to a carriage having an enclosure for receiving and securing a water tank; a mounting pointing incorporated into the enclosure for mounting a water pump; a mounting location for retaining a water heater; floor mounting points for securing the carriage to a van floor; wherein the enclosure includes cutouts to facilitate a viewing of the water level in the water tank; and wherein the enclosure is configured to facilitate building the enclosure and placing the water tank inside enclosure before the enclosure is installed in the van.

Yet another aspect of the invention concerns a locking apparatus having a catch attached to a fixed structure; a pin attached to a moving structure; a rotating latch operatively coupled to rotate on the pin; a dowel attached to the moving structure; wherein the rotating latch comprises a dowel groove configured to receive and operatively couple to the dowel; and wherein the rotating latch is configured to operatively couple to the catch to facilitate retaining the moving structure in a closed position.

In one embodiment, the invention relates to a flat-packed vehicle conversion kit having cabinets having a slotted and curved joint; wherein the slotted and curved joint facilitates making a 90-degree joint, creating a corner that is compliant and reduces the risk of head injuries; a bed module comprising: bed posts; bed frame sides coupled to the bed posts, the bed frame sides configured to support bed planks; bed planks configured to support bed sheets; and bed sheets, supported on the bed planks, the bed sheets configured to support bedding; a cabinet-toilette-shower stall module comprising: a cabinet comprising a storage space and a toilette compartment;
wherein the toilette compartment is configured for stowing a toilette; a shower stall located next to the toilette compartment, wherein the toilette can be moved from the toilette compartment into the shower stall for use of the toilette; and a shower pan with a drain for facilitating the collection and disposal of water used during a shower; and a kitchen module comprising: a kitchen island comprising a kitchen sink and a fridge cabinet; a kitchen cabinet located above the kitchen island; and an auxiliary counter coupled to the kitchen island.

In one embodiment, the invention is directed to a flat packed shipping assembly having a plurality of sheets of material, wherein at least some of the sheets of material contain components of a vehicle conversion kit; a first pallet placed underneath and supporting the plurality of sheets of material; and a second pallet placed on top of the plurality of sheets of material.

One aspect of the invention is directed to a method of manufacturing a vehicle conversion kit. In one embodiment, the method involves providing sheets of material, cutting components of the conversion kit into the sheets of material; and providing tabs that retain the components of the conversion kit in the sheets of material. Another aspect of the invention concerns a method of assembly of a package for flat pack shipment of a vehicle conversion kit. The method can include providing sheets of materials with components of the conversion kit fabricated in the sheet of material; stacking a plurality of said sheets of material; providing a first pallet; placing the sheets of material on top of the first pallet; providing a second pallet; and placing the second pallet on top of the sheets of material.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a top perspective view of a flooring component in accordance with one embodiment of the invention.

FIG. 2 is a bottom perspective view of the flooring component of FIG. 1.

FIG. 3 is a partial top view of another embodiment of a flooring component in accordance with one aspect of the invention.

FIG. 4 is a partial bottom view of the flooring component of FIG. 3.

FIG. 5 is a cross section view of certain components of the flooring component of FIG. 1 in accordance with one embodiment of the invention.

FIG. 6 is a perspective cross section view of the components of FIG. 5.

FIG. 7 is a perspective view of shower curtain rod in accordance with one embodiment of the invention.

FIG. 8 is a perspective view of the shower curtain rod of FIG. 7 in an open position.

FIG. 9 is a perspective view of the shower curtain rod of FIG. 7 in a rotating position.

FIG. 10 is a perspective view of the shower curtain rod of FIG. 7 in a stowed or closed position.

FIG. 11 is a perspective view of a toilette, toilette tray, and shower pan configuration in accordance with one embodiment of the invention.

FIG. 12 plan front view of the toilette, toilette tray, and shower pan of FIG. 11.

FIG. 13 is a partial perspective view of a toilette compartment and slider track for a toilette tray in accordance with one embodiment of the invention.

FIG. 14 is a partial, bottom perspective view of a toilette tray and shower pan in accordance with one embodiment of the invention.

FIG. 15 is a partial, perspective view of vehicle conversion components having certain joining features in accordance with one embodiment of the invention.

FIG. 16 is another partial, perspective view of the components of FIG. 15 showing certain hardware used in joining the components in accordance with one embodiment of the invention.

FIG. 17 is a perspective view of a bracket for facilitating mounting a flooring to a vehicle in accordance with one embodiment of the invention.

FIG. 18 is a cross section view of the bracket of FIG. 17.

FIG. 19 is another cross section view of the bracket of FIG. 17.

FIG. 20 is a perspective view of a tray/counter support assembly in accordance with one embodiment of the invention.

FIG. 21 is perspective view of certain components of the tray/counter support assembly of FIG. 20.

FIG. 22 is a perspective view of the components of FIG. 21 in a closed position.

FIG. 23 is a front perspective view of a headliner in accordance with one embodiment of the invention.

FIG. 24 is a perspective view of a component of the headliner of FIG. 23.

FIG. 25 is back perspective view of the headliner of FIG. 23.

FIG. 26 is a front perspective view of the headliner of FIG. 23 illustrating support for a ceiling panel in accordance with one embodiment of the invention.

FIG. 27 is a perspective view of a carriage system for facilitating assembly, storage, and transport of certain components related to the water system of a vehicle conversion kit in accordance with one embodiment of the invention.

FIG. 28 is a perspective cross section of the carriage system of FIG. 27.

FIG. 29 is another perspective cross section of the carriage system of FIG. 27.

FIG. 30 is a perspective view of certain components of the carriage system of FIG. 27.

FIG. 31 is a cross section perspective view of the components of FIG. 30.

FIG. 32 is a top plan view of a locking system in accordance with one embodiment of the invention.

FIG. 33 is a perspective view of the locking system of FIG. 32 in a locked position.

FIG. 34 is a perspective view of the locking system of FIG. 32 in an open position.

FIG. 35 is a cross section view of the locking system of FIG. 32.

FIG. 36 is a perspective view of a bed module and overhead cabinets in accordance with one embodiment of the invention.

FIG. 37 is a plan view of certain components of the modules of FIG. 36.

FIG. 38 is a perspective view of the components of FIG. 37 assembled in accordance with one embodiment of the invention.

FIG. 39 is a front plan view of a cabinet-toilette-shower (CTS) module in accordance with one embodiment of the invention.

FIG. 40 is a front perspective view of the CTS of FIG. 39.

FIG. 41 is a cross section view of the CTS of FIG. 39 showing the toilette in the stowed position.

FIG. 42 is a partial perspective cross section of the CTS of FIG. 39 showing the toilette in the ready for use position.

FIG. 43 is a back perspective view of the CTS of FIG. 39.

FIG. 44 is a partial perspective view of certain modules of a vehicle conversion kit in accordance with one embodiment of the invention.

FIG. 45 is another partial perspective view of certain modules of a vehicle conversion kit in accordance with one embodiment of the invention.

FIG. 46 is a plan top view of a sheet of material containing certain components of a vehicle conversion kit in accordance with one embodiment of the invention.

FIG. 47 is a plan top view of a sheet of material containing a component of a vehicle conversion kit in accordance with one embodiment of the invention.

FIG. 48 is a plan front view of a shipment assembly for shipping components of a vehicle conversion kit in accordance with one embodiment of the invention.

FIG. 49 is a perspective view of the shipment assembly of FIG. 48.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Interlocking Floor

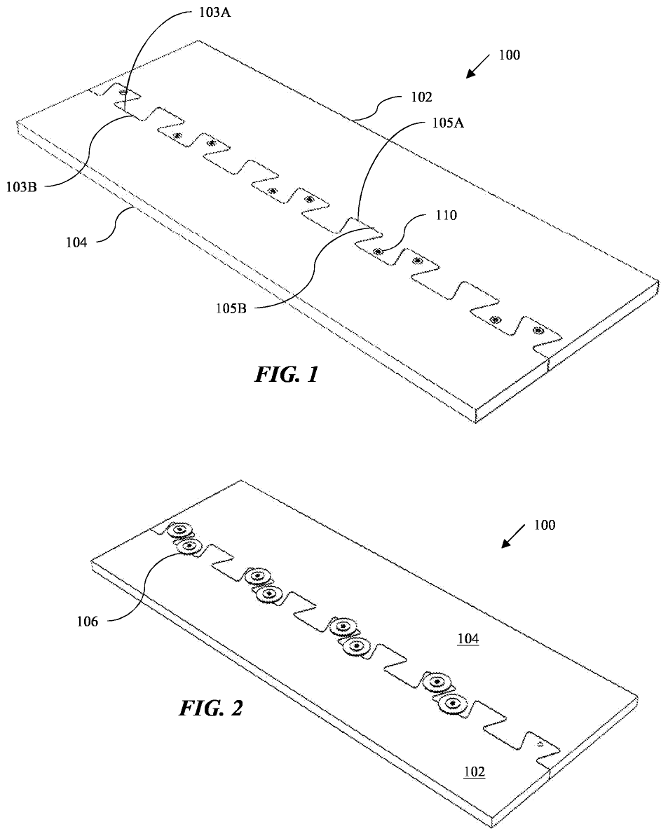

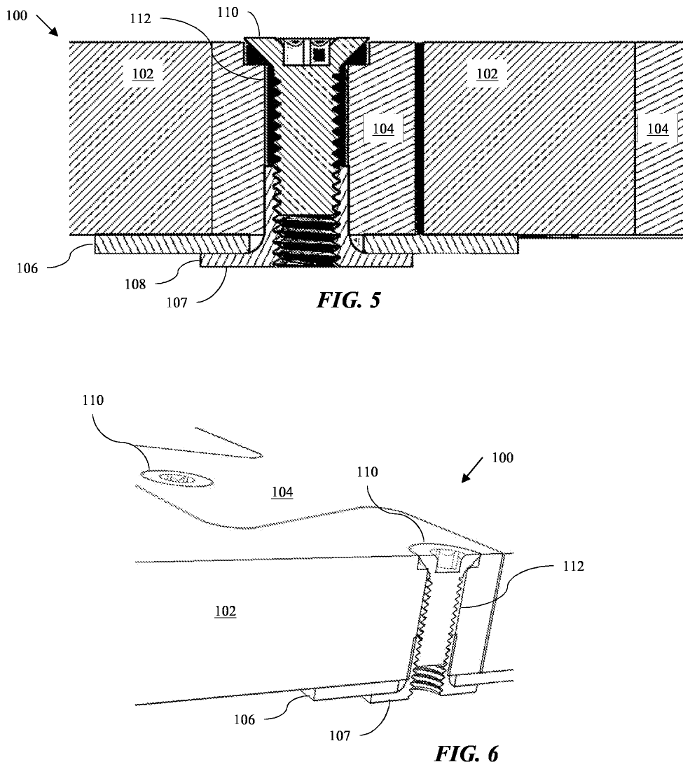

Referencing FIG. 1 through FIG. 6, in one embodiment the invention concerns floor 100 having interlocking floor sections 102, 104. Floor 100 can include washer 106 retained on the bottom side of floor 100 by insert 108. In one embodiment, bolt 110 on the top of the floor holds washer 106 and insert 108 in place. Washer 106 can be configured to keep floor sections 102, 104 together and prevent separation of either floor section 102, 104 when a load is exerted on a floor section 102, 104. Bolt hole 112 is suitably located close to the end of floor section 102. 104 to facilitate overlapping washer 106 across floor sections 102, 104. In some embodiments, insert 108 can include flange 107 and threads to receive threads of bolt 110. In one embodiment, floor 100 provides a method of preventing separation of floor sections 102, 104 and of locking in a floor for a van, for example.

Floor 100 can provide ease of manufacturing, ease of assembly, lower cost of production, and increased durability. Floor 100 can facilitate cutting floor sections 102, 104 from one side with a single operation. The interlocking fit facilitates alignment in the horizontal plane. Bolt 110, washer 106, and threaded insert 108 vertically align and also prevent vertical movement of floor sections 102, 104.

Known floor systems do not have the self-alignment interlocking fit, like a puzzle fit. During regular use of an interlocking floor, a user's weight on the floor can cause uneven pressure on the floor and, thereby, cause separation of floor sections. However, floor 100 is configured to prevent separation during regular use.

Floor 100 can be made of, for example, pre-laminated plywood cut on a CNC machine. Manufacturing floor 100 does not require tool changes and can be done in a single operation. The assembly of bolt 110 and washer 106 can be done by, for example, an installer or do-it-yourself end user.

The interlocking design facilitates self-alignment of floor sections 102, 104 making assembly easier. In one embodiment, the interlocking shape can include a peninsula of material that facilitates the overlapping of washer 106 of the surrounding material from the other floor section 102, 104. In one embodiment, floor section 102, 104 can include at least one side having a pattern of alternating tabs 103 and notches 105. In some embodiments, tabs 103A of section 102 are configured to interlock with notches 103B of section 104, and notches 105A of section 102 are configured to interlock with tabs 105B of section 104. Washer 106 can be held in place by insert 108 and a bolt 110. Insert 108 can be press fit into a floor section 102, 104. Washer 106 and bolt 110 can be configured to prevent movement in a vertical direction while the interlock fit prevents movement in a horizontal direction.

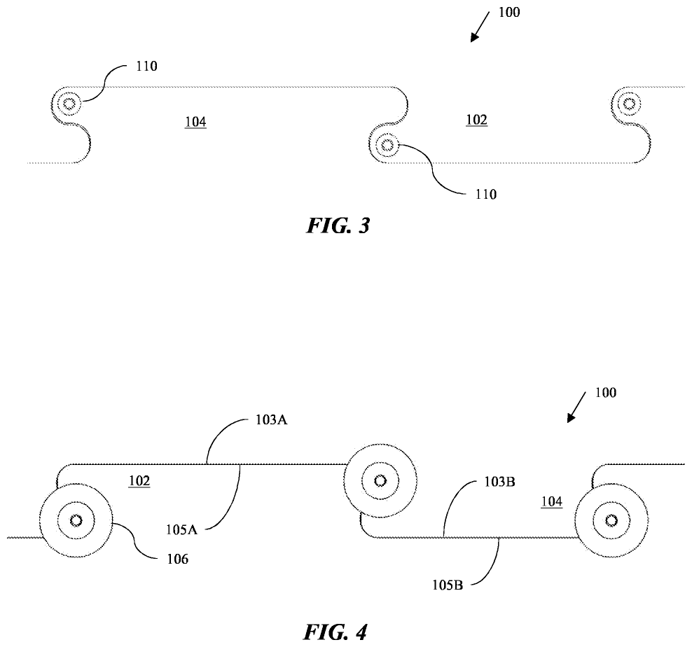

In some embodiments, the shape of the interlock can vary. A puzzle shaped connection can maximize the amount of overlap. Adding glue to the seam is recommended but optional. In some embodiments, such as that illustrated in FIG. 1 and FIG. 2, bolt 110 can be placed centrally on a tab 103A, for example, and washer 106 can be placed overlapping tab 103A and notch 103B, for example. In certain embodiments, such as that illustrated in FIG. 3 and FIG. 4, bolt 110 can be located on or about a corner of tab 103A and notch 105B, for example. Washer 106 can be placed overlapping the corners of tab 103A and notch 105B, for example. The different placements of washer 106 can provide for different stability and rigidity of floor 100.

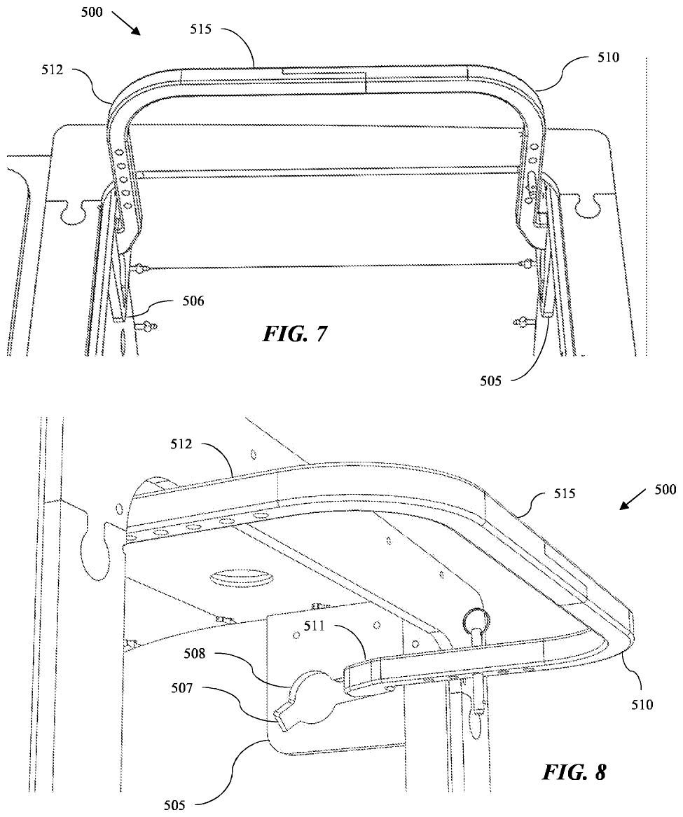

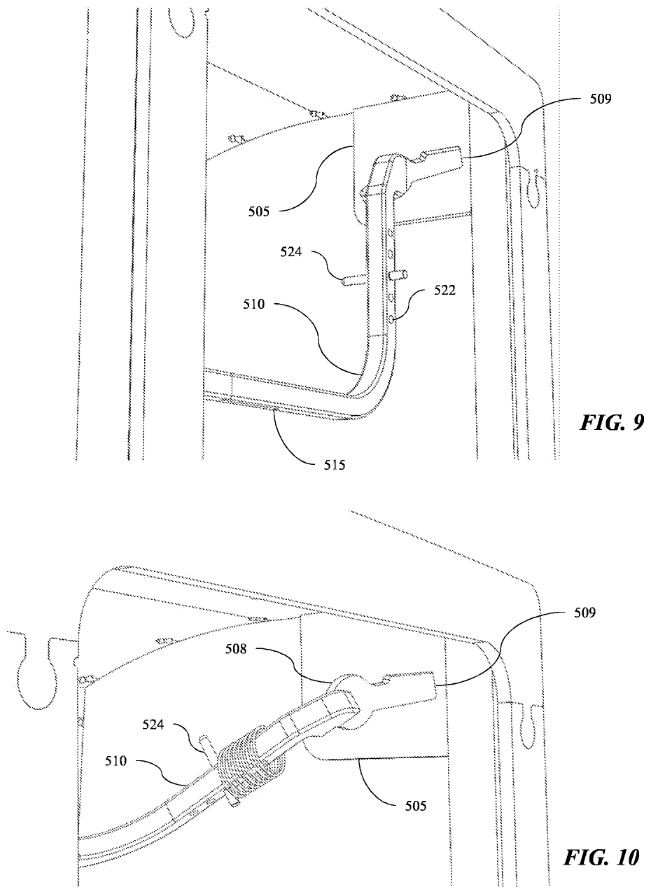

Referencing FIG. 7 through FIG. 10, rod 500 can be configured to rotate outwards to an open position (FIG. 7-8) to provide more space during showering, for example, and then to rotate inward (FIG. 9) to a closed position (FIG. 10) for better storage. In some embodiments, rod 500 can be used as a shower curtain rod and/or clothes hanger rod, for example. In one embodiment, rod 500 is mounted on rod bracket 505 that allows rod 500 to easily rotate (FIG. 9) and lock into place in either the outward position (FIG. 8) or an inward position (FIG. 10). In one embodiment, rod 500 includes right rod arm 510 that connects via hanging bar 515 to left rod arm 512; left rod arm 512 is substantially similar to right rod arm 510.

In some embodiments, rod bracket 505 can include closed locking slot 507 configured to receive right distal end 511 of right rod arm 510 and to retain right rod arm 510 in a closed position. In certain embodiments, bracket 505 can include open locking slot 509 configured to receive right distal end 511 and to retain right rod arm 510 in an open position (FIG. 8).

In one embodiment, rod bracket 505 can include rotation space 508 configured to facilitate rotation of right rod arm 510 from a closed position to an open position and vice versa. Rotation space 508 is preferably located between, and connects, closed locking slot 507 and open locking slot 509. In one embodiment, closed locking slot 507 is configured to be positioned having a relatively downward angle to facilitate a gravity assisted placement of right distal end 511 into closed locking slot 507. In some embodiments, second rod bracket 506 having closed locking slot and open locking slot substantially similar to, respectively, closed locking slot 507 and open locking slot 509 can be provided to couple to a distal end of left rod arm 512. Second rod bracket 506 can also be provided with a rotation space substantially similar to rotation space 508.

In some embodiments, rod 500 can be provided with dowel holes 522 for receiving dowel pin 524. Preferably, dowel pin 524 can be configured to facilitate retaining shower curtain rings 526 from falling to hanging bar 515 when rod 500 is placed in the stowed position. Without shower curtain rings 526 interfering, rod 500 can be used, for example, to hang clothes or towels.

Rod 500 can be used in vans and other vehicles where space is critical. Rod 500 facilitates switching between a position for more space (FIG. 8) while using the shower and a position that is ideal when not using the shower (FIG. 10).

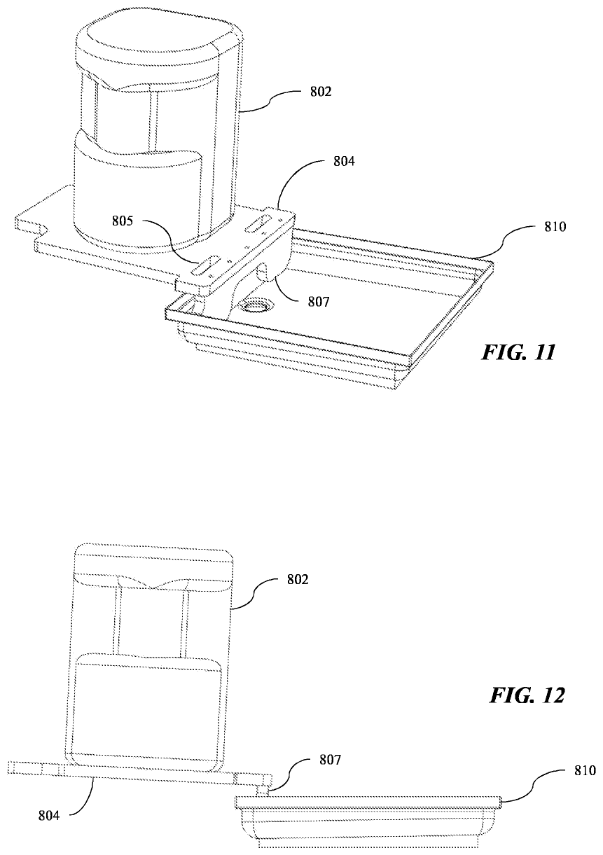

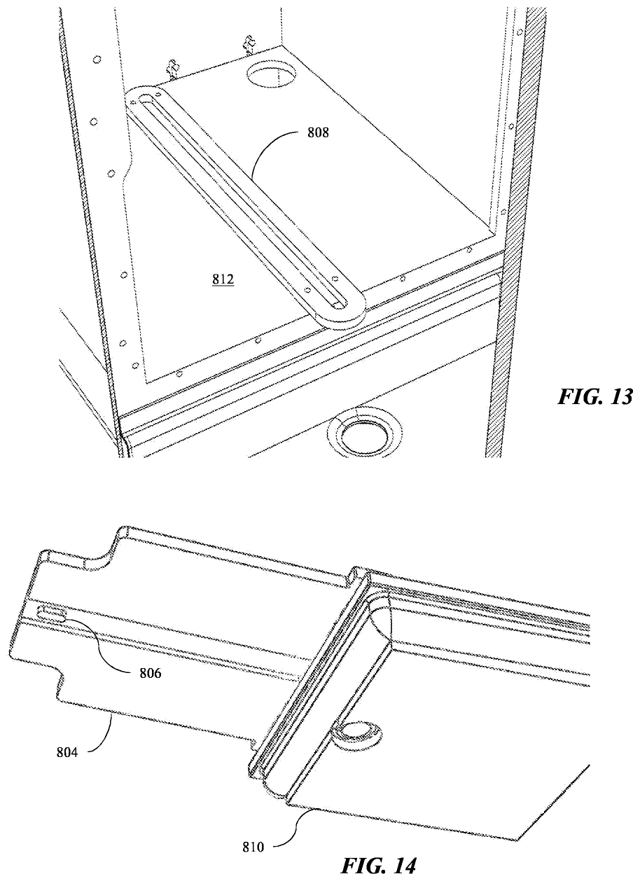

Referencing FIG. 11 through FIG. 14, in one aspect the invention is related to toilette 802, shower pan 810, and/or their combination. In some embodiments, toilet 802 can be supported on toilette tray 804. In one embodiment, a mechanism facilitates sliding toilet 802 on toilette tray 804 for easier access. Toilette tray 804 and tray slider 806 can be configured to keep toilette tray 804 aligned and to prevent overextension in either direction. In one embodiment, toilette tray 804 can include slider 806 configured to operatively couple with slider track 808. Slider track 808 can be coupled, for example, to fixed support structure 812. In some embodiments, toilette tray 804 is configured to slide insider and/or over a length of shower pan 810. In certain embodiments, toilette tray 804 can include one more handles 805 to facilitate a back and forth sliding of toilette 802 for sliding between an in-use position and a stowed position. In some embodiments, handles 805 can be, for example, cutouts in toilette tray 804. In one embodiment, toilette tray 804 can be provided with tray feet 807 configured to provide support for toilette tray 804 in shower pan 810, and to facilitate sliding toilette tray 804 in shower pan 810. In the embodiment of FIG. 11 and FIG. 12, toilette 802 is shown in the stowed position, which provides room for use of shower pan 810.

Cabinetry Assembly System

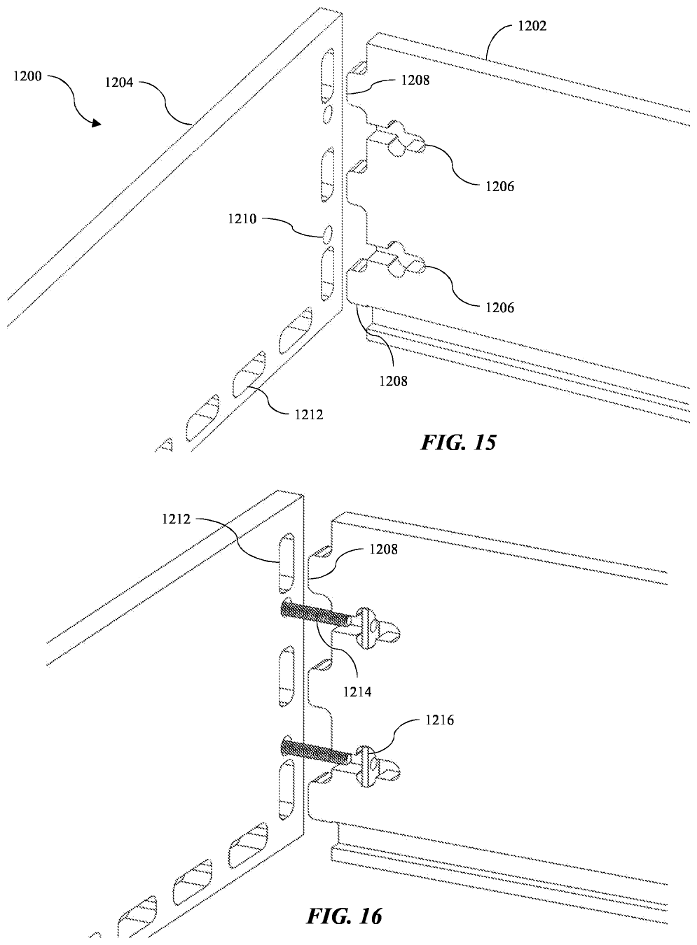

Referencing FIG. 15 and FIG. 16, in one embodiment assembly system 1200 can be configured for facilitating building and coupling cabinetry components. In some embodiments, system 1200 consists of anchoring board 1202 configured to operatively couple to joining board 1204. Anchoring board 1202 can include t-shaped pockets 1206 and tabs 1208. In one embodiment, joining board 1204 can include bolt holes 1210 and tab pockets 1212 that correspond, respectively, with t-shaped pockets 1206 and tabs 1208. In some embodiments, t-shaped pocket 1206 is configured to facilitate receiving and retaining nut 1216. Anchoring board 1202 and joining board 1204 can be aligned using tabs 1208 to match tab pockets 1212. In certain embodiments, bolt 1214 is configured to go through bolt hole 1210 and lock in place by threading into nut 1216 in t-shaped pocket 1206.

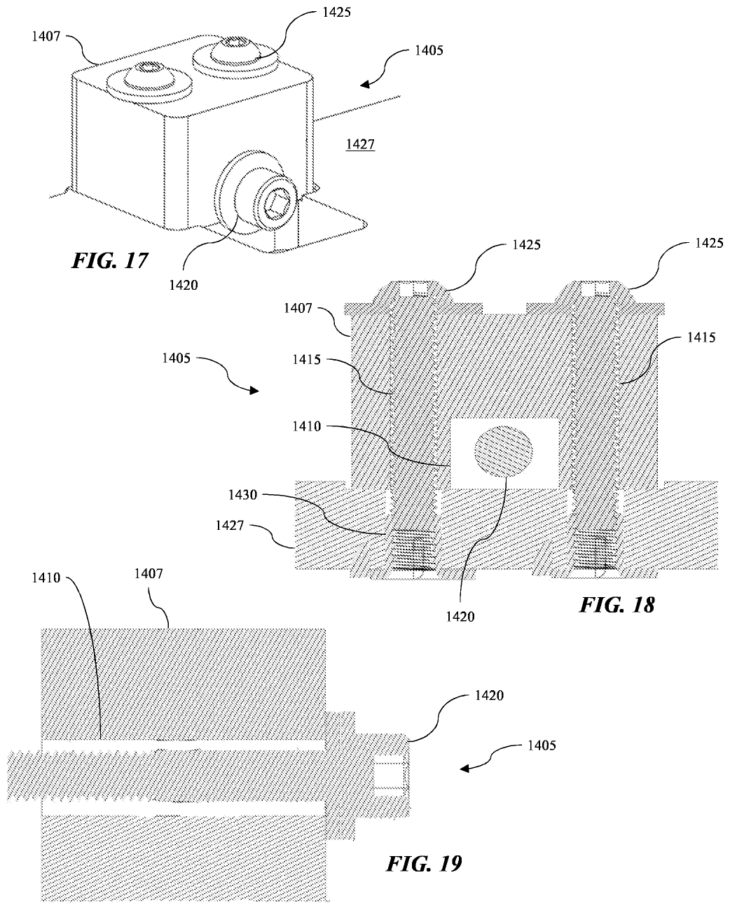

Referencing FIG. 17-FIG. 19, it is illustrated a method of mounting a floor of a vehicle to the interior walls of a vehicle. In one embodiment, a floor section with two threaded inserts per bracket can be provided. In some embodiments, bracket 1405 can include bracket body 1407 having channel 1410 and bolt holes 1415. Channel 1410 can be configured to facilitate passing bolt 1420 through and securing bracket 1405 to a wall of the vehicle. Bolt holes 1415 can be configured to facilitate mounting bracket 1405 with bolts 1425 to floor 1427 having floor threaded inserts 1430.

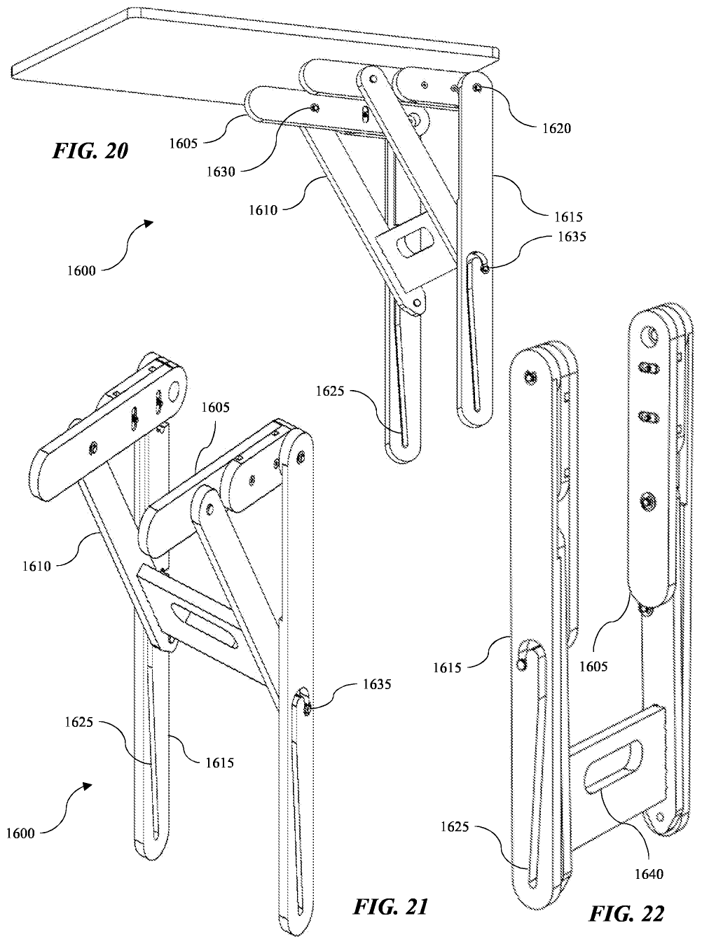

Referencing FIG. 21-FIG. 22, it is illustrated a method and system for facilitating providing and folding away a tray or countertop. In one embodiment, tray support 1600 can include mounting arms 1605, moving arms 1610, and fixed arms 1615. In one embodiment, fixed arm 1615 can include pivot hole 1620 at a distal end of fixed arm 1615; pivot hole 1620 can be configured to provide a point of rotation for mounting arms 1605. In some embodiments, fixed arm 1615 can include, at the other distal end, j-slot 1625. Moving arm 1610 can be configured to be coupled, at a distal end of moving arm 1610, to the mounting arms 1605 with pivot hole 1630. The other distal end of moving arm 1610 can be coupled to fixed arm 1615 with pin 1635 configured to follow j-slot 1625 cut out in fixed arm 1615. The shape of j-slot 1625 can be configured to facilitate sliding of pin 1635 in fixed arm 1615 to lock into an upright position (FIG. 20, FIG. 21) or to fold down into a stowed position (FIG. 22). Mounting arms 1605 are suitably configured to support, for example, counter and/or tray 1640. In one embodiment, tray support 1600 can include positioning handle 1645 configured to facilitate moving tray support 1600 from a deployed position (FIG. 20) to a stowed position (FIG. 22). Positioning handle 1645 can be configured, in some embodiments, to facilitate the movement of pin 1635 in j-slot 1625. In some embodiments, tray support 1600 can be suitably supported by and/or coupled to fixtures of the vehicle, such as cabinetry and/or walls.

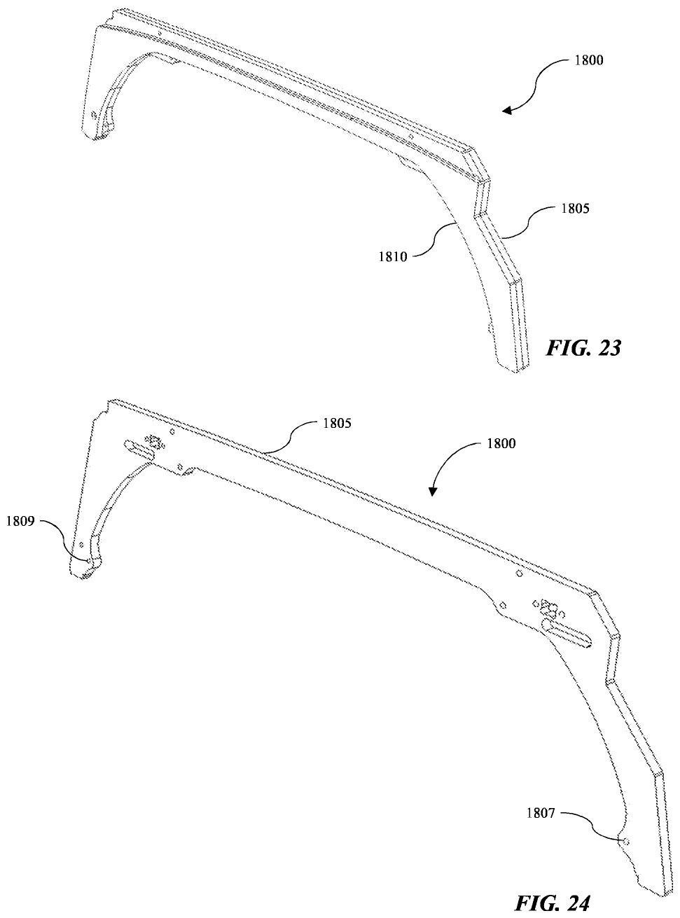

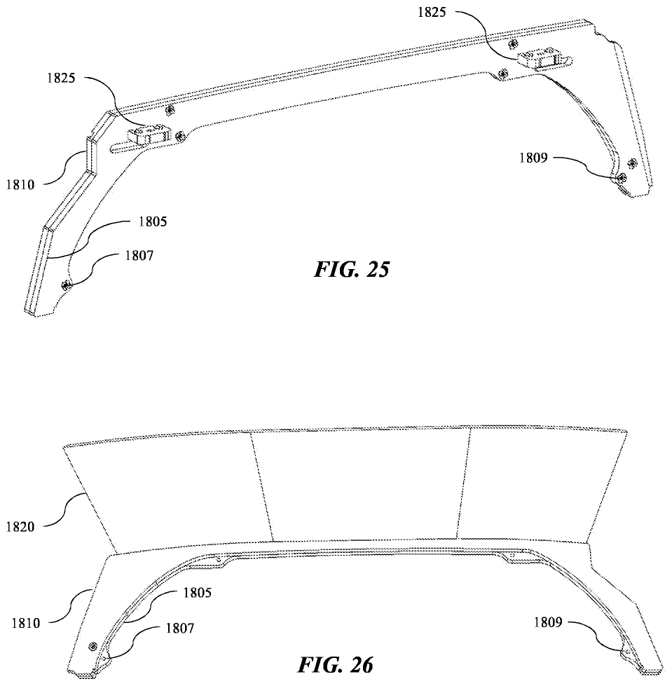

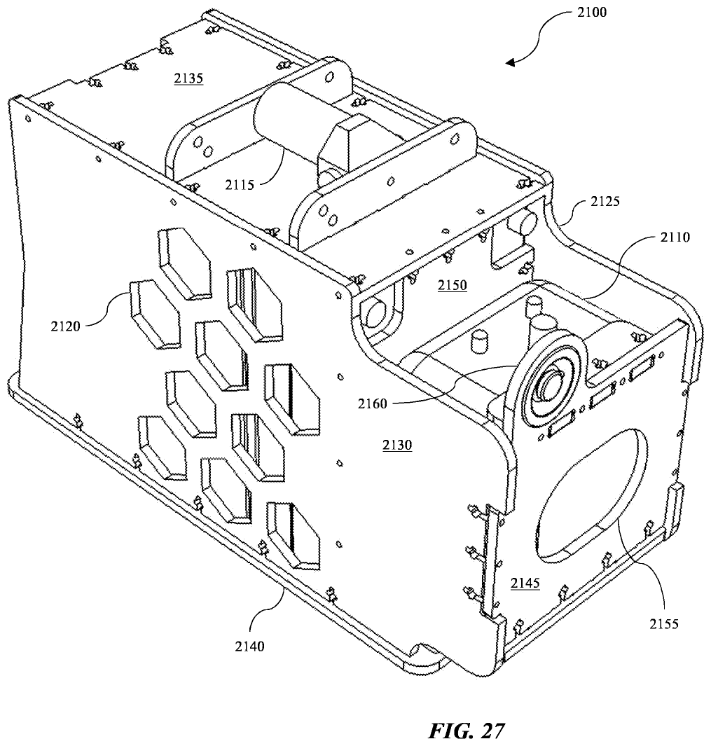

In some vehicles there can be a visible gap between the headliner in the cabin area and the frame of the vehicle. In such situations, there is no easy way to add a curtain to divide the cabin area from the rest of the vehicle. Additionally, typically there is no mountings for ceiling paneling. Referencing FIG. 23 through FIG. 26, it is illustrated headliner system 1800 configured to facilitate covering the headliner gap, providing mounting points for a curtain, and securing a ceiling panel.

In one embodiment, headliner system 1800 can include cross boards 1805, 1810 configured to couple to mounting brackets (not shown) suitable coupled to the wall of the vehicle or another fixed structure (such as cabinetry, for example). Cross boards 1805, 1810 can be configured to span the width of the headliner and to cover the gap between the headliner and the vehicle frame. In one embodiment, cross boards 1805, 1810 can be stacked on top of one another, as illustrated. In some embodiments, a bottom of cross boards 1805, 1810 can include connection points 1807, 1809 for attaching cross boards 1805, 1810 to the mounting brackets. In one embodiment, cross board 1810 can be configured with groove 1815, which groove 1815 can be suitably shaped and configured to receive and support part of ceiling paneling 1820. In some embodiments, headline system 1800 can include cross board brackets 1825 to facilitate, for example, coupling headliner system 1800 to a vehicle fame or other structure coupled to the vehicle.

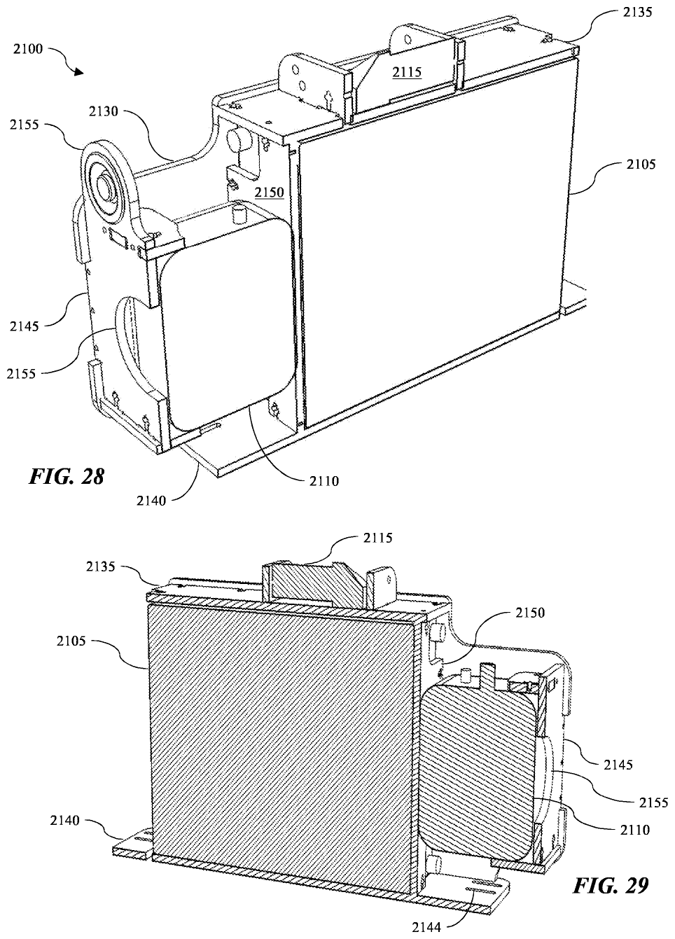

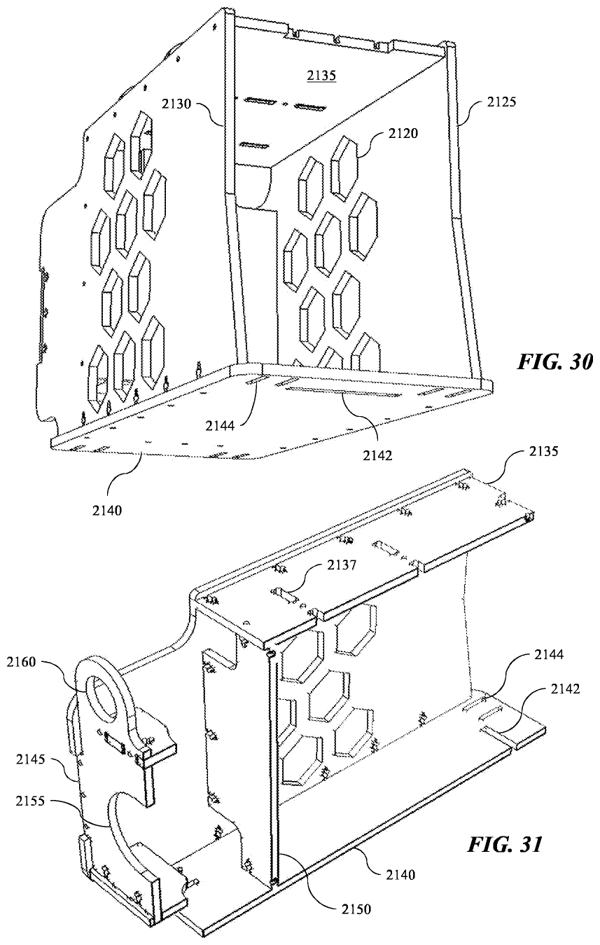

Referencing FIG. 27-31, it is illustrated a method and system for using carriage 2100 to secure water tank 2105 in a confined space to, among other things, limit movement of water tank 2105 while the vehicle is moving, to secure water heater 2110, and to mount water pump 2115. In one embodiment, carriage 2100 can be configured to facilitate assembling carriage 2100 outside a vehicle before placing carriage 2100 inside the vehicle and bolting carriage 2100 to the vehicle floor, for example. In one embodiment, carriage 2100 can include side panel sheets (or carriage walls) assembled with water tank 2105 placed inside. Cutouts 2120 on the sides of carriage 2100 are configured to, among other things, facilitate viewing the water level in water tank 2105. Mounting points at the bottom of carriage 2100 facilitate bolting carriage 2100 to the vehicle floor.

In some embodiments, carriage 2100 is configured to facilitate working with the plumbing system outside of the vehicle. In certain embodiments, carriage 2100 can be configured to provide a mounting location for water heater 2110 close (or adjacent) to water tank 2105 to minimize piping.

In one embodiment, carriage 2100 can include mounting slots and/or bolt holes on the bottom to allow secure mounting to the van floor. In some embodiments, water pump 2115 can be mounted on top of carriage 2100 to facilitate pulling water from water tank 2105 and to supply the water to water heater 2110 and to rest of the vehicle's plumbing.

It is known to secure water tanks using straps. Embodiments disclosed here improve, among other things, on the strap securing method by facilitating easier removal of water tank 2105 (by removal of carriage 2100 containing water tank 2105), by avoiding the application of compression forces as the straps normally do, and by facilitating installing and/or removing a substantial part of the water system at the same time (that is, in removing/installing carriage 2100 with water tank 2105, water heater 2110, and water pump 2115, the major components of the water system can be removed/installed at the same time).

In one embodiment, carriage 2100 can include carriage right side panel 2125, carriage left side panel 2130, carriage top side panel 2135, carriage bottom side panel 2140, and carriage front side panel 2145. In certain embodiments, carriage 2100 can include a carriage back side panel (not shown). In some embodiments, carriage 2100 can include carriage divider panel 2150 configured to facilitate dividing carriage 2100 into a first compartment for water tank 2105 and a second compartment for water heater 2110. In one embodiment, carriage 2100 can be provided with mounting point 2160 for receiving and/or retaining a fresh water fill port, for example. Fresh water fill port mount 2160 can be part of, for example, carriage front side panel 2145.

In certain embodiments, carriage top side panel 2135 can be provided with top panel slots 2137 configured to facilitate coupling water pump 2115 to carriage top side panel 2135. In one embodiment, carriage front side panel 2145 can be provided with front panel cutout 2155 configured to facilitate, for example, accessing the controls of water heater 2110. In some embodiments, carriage bottom side panel 2140 can be provided with bottom panel slots 2142, 2144 to, for example, facilitate coupling carriage 2100 to the vehicle floor.

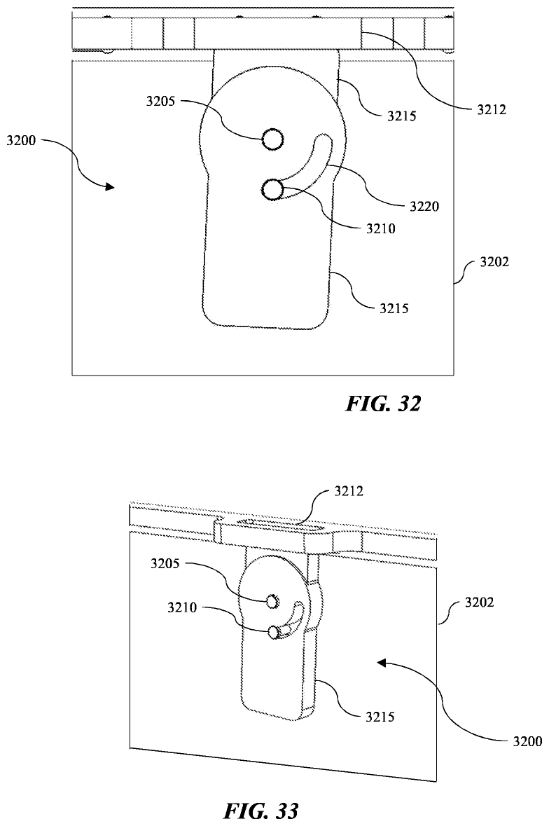

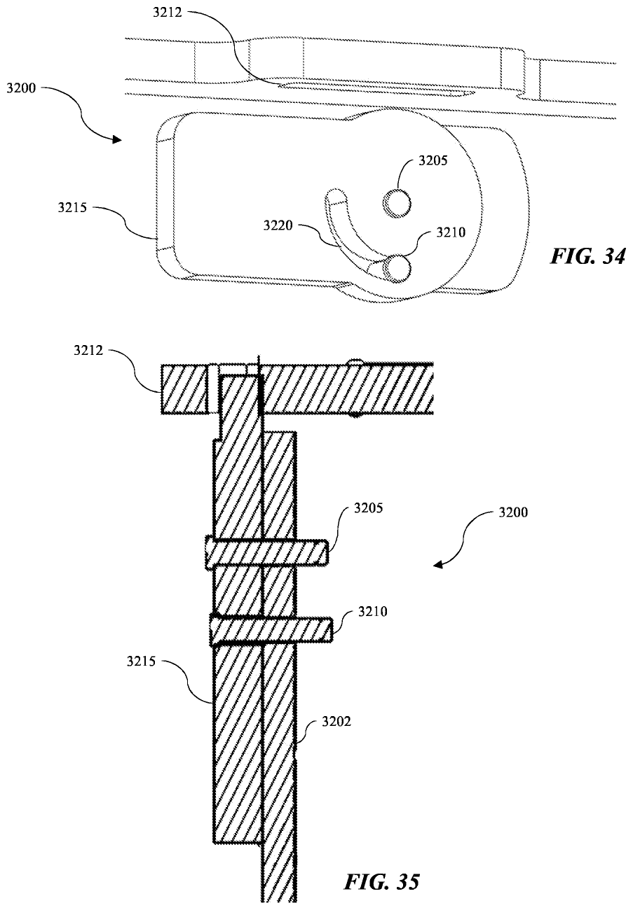

Referencing FIG. 32 through FIG. 35, it is illustrated lock 3200 for locking drawers and doors to prevent them from opening during movement of the vehicle. Component parts of lock 3200 can be cut on, for example, a CNC machine. In some embodiments, lock 3200 can be coupled to drawer door 3202, for example. In one embodiment, lock 3200 can include lock pin 3205, clevis pin 3210, fixed catch 3212, and rotating bar 3215. In some embodiments, rotating bar 3215 is configured to be rotatable about lock pin 3205, which lock pin 3205 can be coupled to both rotating bar 3215 and drawer door 3202. In certain embodiments, lock pin 3202 can be, for example, a suitable bolt coupled to drawer door 3202 with suitable washers and clips.

In some embodiments, rotating bar 3215 can include guide slot 3220 that, among other things, provides a stop as guide slot 3220 abuts against clevis pin 3210 in the open or closed position of rotating bar 3215. FIG. 32 shows rotating bar 3215 in a closed position, while FIG. 34 shows rotating bar 3215 in an open position. When rotating bar 3215 is rotated to the open position, rotating bar 3215 is freed from fixed catch 3212, thereby allowing drawer door 3202 to be pulled away into an open position. In one embodiment, fixed catch 3212 is coupled to and/or formed in catch structure 3214. In some embodiments, fixed catch 3212 can be a cutout in catch structure 3214 positioned next to drawer door 3202, which fixed catch 3212 is configured to hold and/or obstruct a free movement of rotating bar 3215 when rotating bar 3215 is in the closed/locked position. From the open position (FIG. 34), when rotating bar 3215 is released, rotating bar 3215 rotates under the gravitational force into the locked position (FIG. 32).

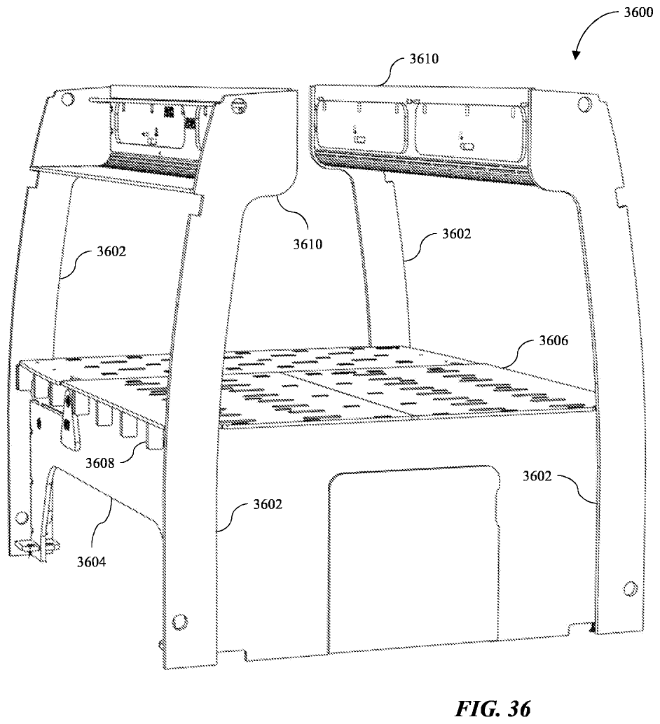

FIG. 36 illustrates an embodiment of certain components of a van conversion kit. In one embodiment, a van conversion kit can include bed module 3600 having bed posts 3602, bed frame sides 3604, bed sheets 3606, and bed planks 3608. In some embodiments, bed module can include, bed face 3610 with trap door 3612. Bed posts 3602 are configured to be coupled to a vehicle (or cabinetry in the vehicle) in a configuration that substantially defines a rectangular space for accommodating bed frame side 3604, bed sheets 3606, and bed planks 3608. In some embodiments, distal ends 3610 of bed posts 3602 are configured to form at least part of overhead cabinets 3612.

In certain embodiments, bed frame sides 3604 extend from a bed post 3602 to another bed post 3602, thereby providing support for bed planks 3608, which bed planks 3608 extend from one bed frames side 3604 to another bed frame side 3604. Bed sheets 3606 can be placed on or coupled to bed planks 3608. A mattress, or other suitable bedding, can be placed on the bed sheets 3606. In one embodiment, bed face 3610 can include trap 3612 to, for example, allow access to a space formed below bed sheets 3606 and bed planks 3608. The space so formed can be used to, for example, store items and/or receive carriage 2100 (FIG. 27-31).

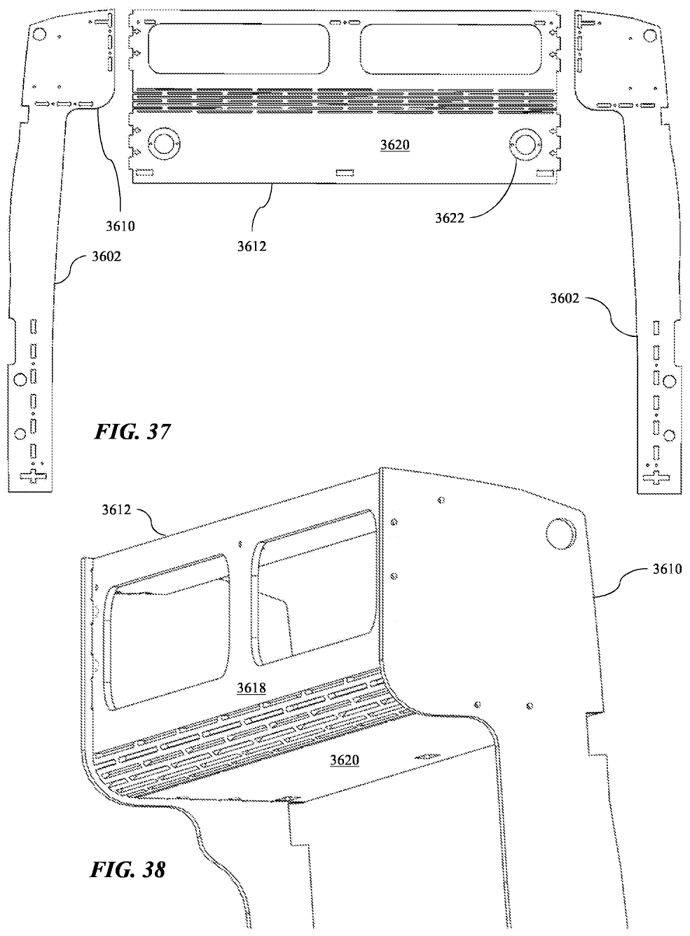

FIG. 37-38 illustrate one embodiment of bed posts 3602 configured to form part of, and support, cabinets 3612. Lateral sides 3610 (the distal ends of bed posts 3602) are configured to provide lateral side walls of cabinets 3612. In some embodiments, cabinets 3612 includes cabinet front side 3618 and cabinet bottom side 3620. In certain embodiments, slotted joint 3622 provides an integrated joint between cabinet front side 3618 and cabinet bottom side 3620. Slots 3624 in slotted joint 3622 facilitate providing a curved, 90-degree joint. Slots 3624 can be long, lateral, and intermittent slots. The corner made by the bent material is compliant and, compared to a square corner, reduces the risk of head injuries while still being made of the same material as the rigid construction material of cabinets 3612. In one embodiment, cabinet front side 3618, slotted joint 3622, and cabinet bottom side are formed in a single piece of material (FIG. 37). In some embodiments, cabinets 3612 can include light cutouts 3622 for facilitating the installation of cabinet lights. The configuration of cabinet 3612 illustrated in FIG. 37-38 allows for, among other things, cabinet 3612 to be flat packed and reduces the part count and cost significantly compared to other designs. In one embodiment, slotted join 3622 can be coupled to cabinet front side 3618 and cabinet bottom side 3620 with pocket and tenon, for example. In other embodiments, bolts can be used to couple slotted join 3622 to cabinet front side 3618 and cabinet bottom side 3620.

Cabinets 3612 can provide storage space for, for example, clothing, food, and other essentials. The design of cabinets 3612 allows for maximum storage capacity while minimizing the amount of floor space taken up in the vehicle. In one embodiment, cabinets 3612 can be assembled and mounted to the roof of the vehicle and can be, preferably, customized to fit the specific dimensions of a specific vehicle.

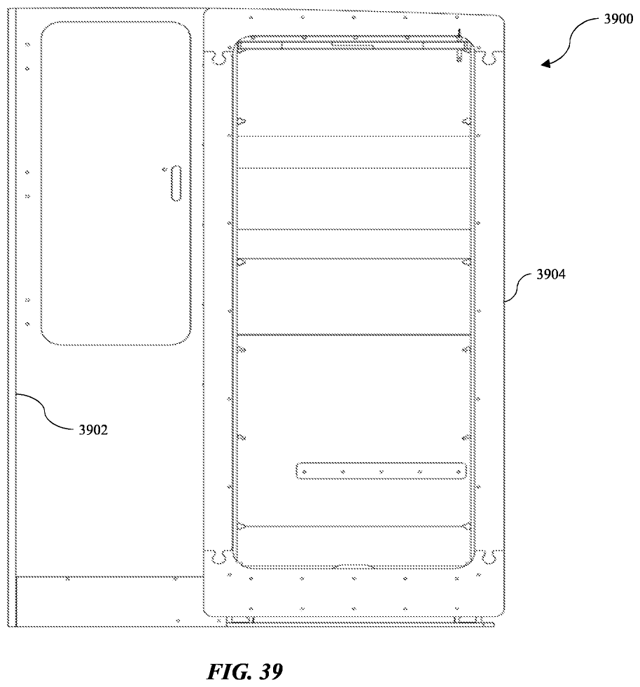

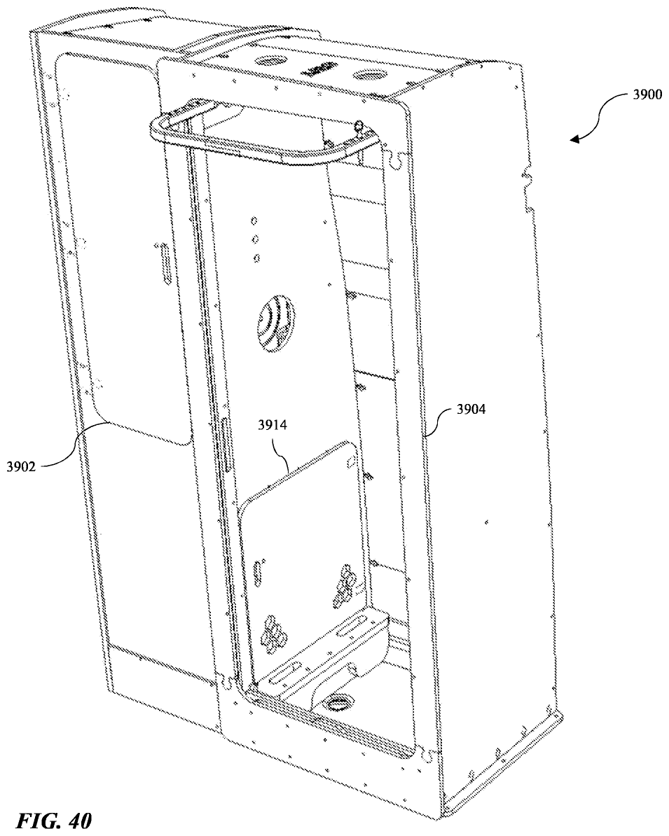

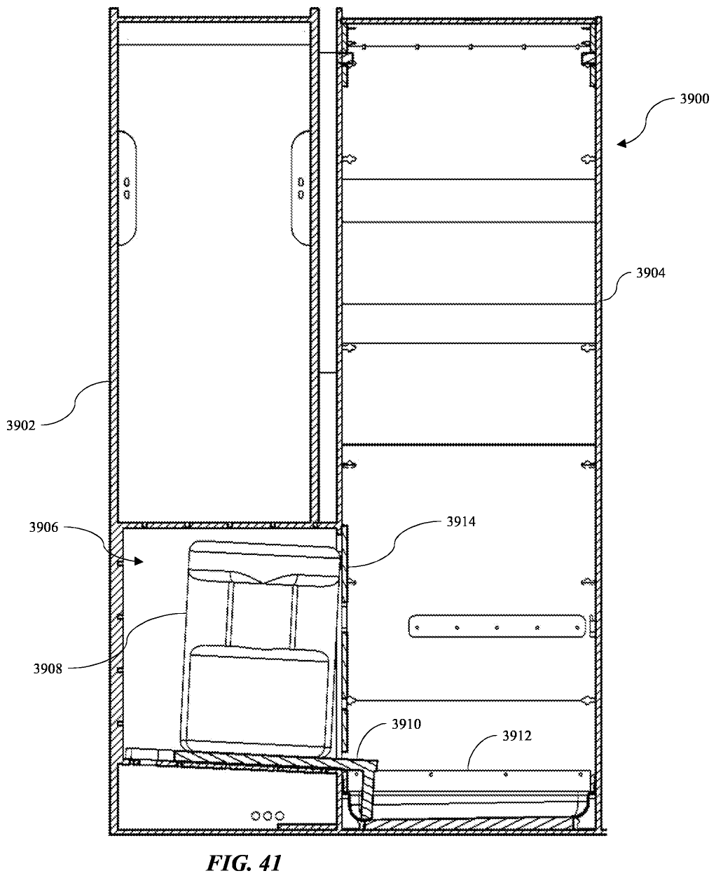

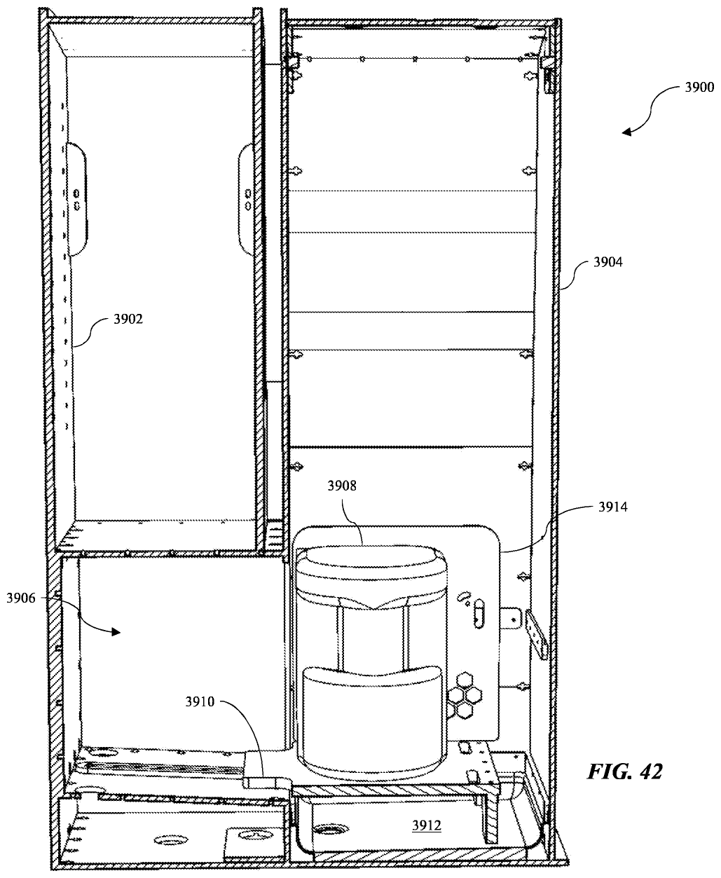

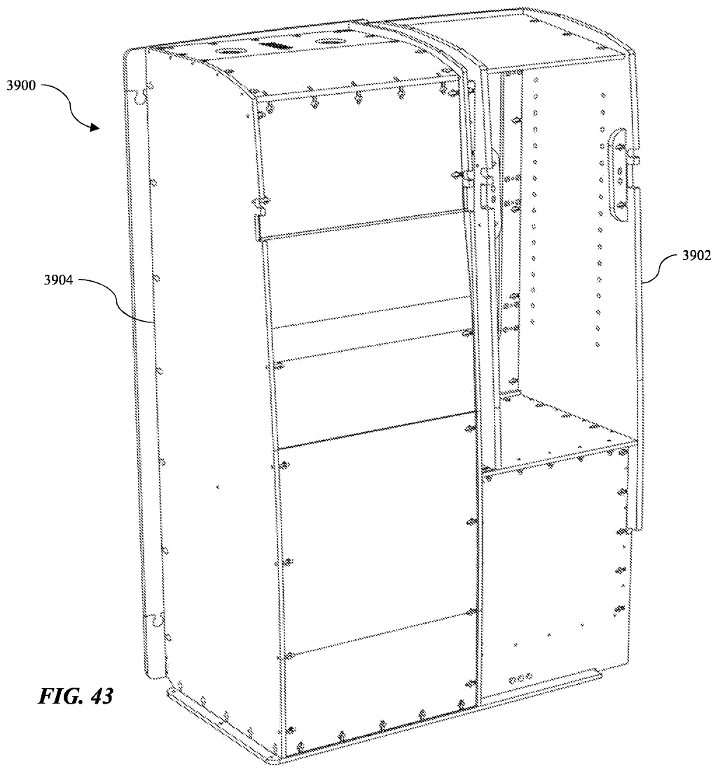

Referencing FIG. 39-43, in one embodiment, a van conversion kit can include a cabinet-toilette-shower (“CTS”) module 3900. In some embodiments, CTS module 3900 can include cabinet 3902 located next to, or coupled to, shower stall 3904. In certain embodiments, cabinet 3902 can include toilette compartment 3906 configured to accommodate toilette 3908. In one embodiment, toilette 3908 is placed on toilette tray 3910. When not in use, toilette 3908 can be stowed away in toilette compartment 3906 (FIG. 41), which toilette compartment 3906 can be part of cabinet 3902 and/or located below a cabinet space of cabinet 3902. For use, toilette 3908 can be pulled into use position by sliding toilette tray 3910 along shower pan 3912 (FIG. 42). In some embodiments, toilette compartment door 3914 can be provided to, for example, hide toilette 3908 and/or keep water from falling into toilette compartment 3906 when the shower stall 3904 is used for showering. As can be seen in the embodiment of FIG. 42, shower stall 3904 can be configured to also serve as a bathroom by the advantageous configuration of cabinet 3902 having toilette compartment 3906, and toilette 3908 configured to slide from toilette compartment 3906 into shower stall 3904.

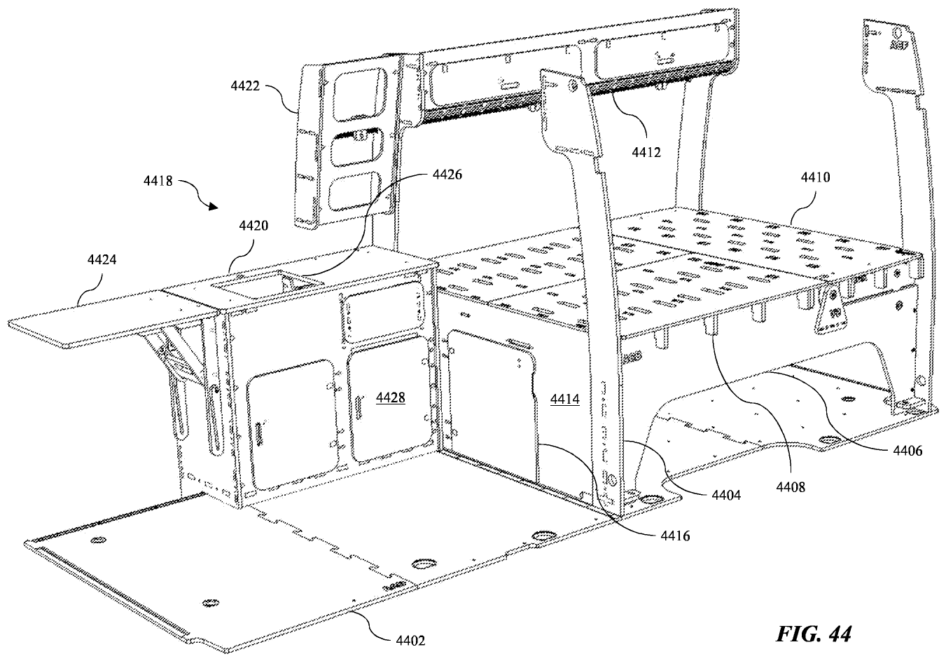

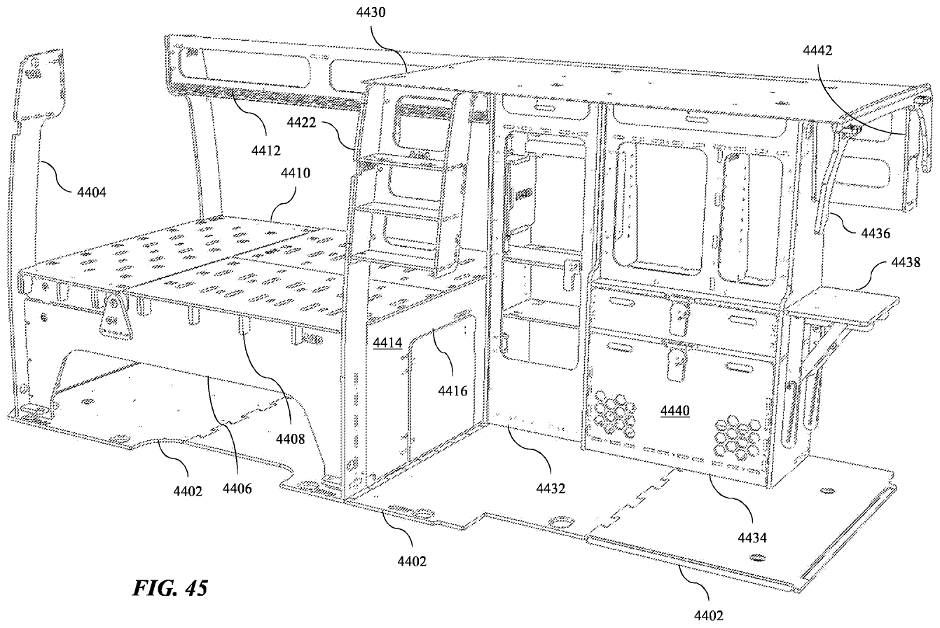

Referencing FIG. 44-45, in one embodiment a vehicle conversion kit can include flooring panels 4402. In some embodiments, bed posts 4404 can be coupled to at least some of flooring panels 4402 and/or structures of the vehicle. Bed posts 4404, bed frame sides 4406, and bed planks 4408 can be configured to support bed sheets 4410 to provide support for a bed. In certain embodiments, the bed module is preferably put into place towards the rear of the vehicle. Bed planks 4408 can be configured to span transversely, substantially, from one side of the vehicle to the opposite side.

Above the bed module, in one embodiment, there can be overhead cabinets 4412. Bed posts 4404 can be configured to support and/or couple to overhead cabinets 4412. In some embodiments, bed front side panel 4414 can be provided to support and/or couple to bed sheets 4410, as well as to close off a space from beneath bed sheets 4410 and bed planks 4408 from the rest of the vehicle space and/or furniture. In certain embodiments, bed front side panel 4414 can be provided with access door 4416 to, for example, allow access to the space beneath the bed. In some embodiments, carriage 2100 (FIG. 27) can be located underneath the bed module in the space beneath the bed sheets 4410.

In one embodiment, the conversion kit can include kitchen module 4418. In some embodiments, kitchen module 4418 can include kitchen island 4420, kitchen cabinet 4422, and/or auxiliary counter 4424. Kitchen cabinet 4422 can be, for example, a spice rack. In certain embodiments, kitchen cabinet 4422 can be located above kitchen island 4420, and can be coupled to, for example, a bed post 4404. In one embodiment, kitchen island 4420 can include kitchen sink 4426 and fridge cabinet 4428.

Referencing FIG. 45, in one embodiment the van conversion kit can include ceiling paneling 4430. Only one panel 4430 is shown; however, multiple panels configured to cover the entire ceiling of the vehicle can be provided. In certain embodiments, header bar 4436 can be provided to, among other things, facilitate securing ceiling paneling 4430, covering the ceiling gap, and/or supporting a curtain (for example) to divide the cabin from the rest of the vehicle.

In some embodiments, opposite to kitchen island 4420, utility cabinet 4432 and pantry 4434 can be provided. Utility cabinet 4432 can include one or more compartments and shelves configured to accommodate, for example, electrical components, HVAC components, and/or plumbing components that support living activities in the converted vehicle. Pantry 4434 can include one more pantry drawers 4440 configured to, for example, store foodstuffs and other sundries. In certain embodiments, the van conversion kit can include auxiliary table 4438 coupled to and/or located next to pantry 4434. In one embodiment, gap cabinet 4442 can be provided next to and/or coupled to pantry 4434 and above auxiliary table 4438. In one embodiment, one or both of utility cabinet 4432 and pantry 4434 can be replaced by CTS module 3900 (FIG. 39-43); thereby providing toilette facilities and a shower stall opposite kitchen island 4420.

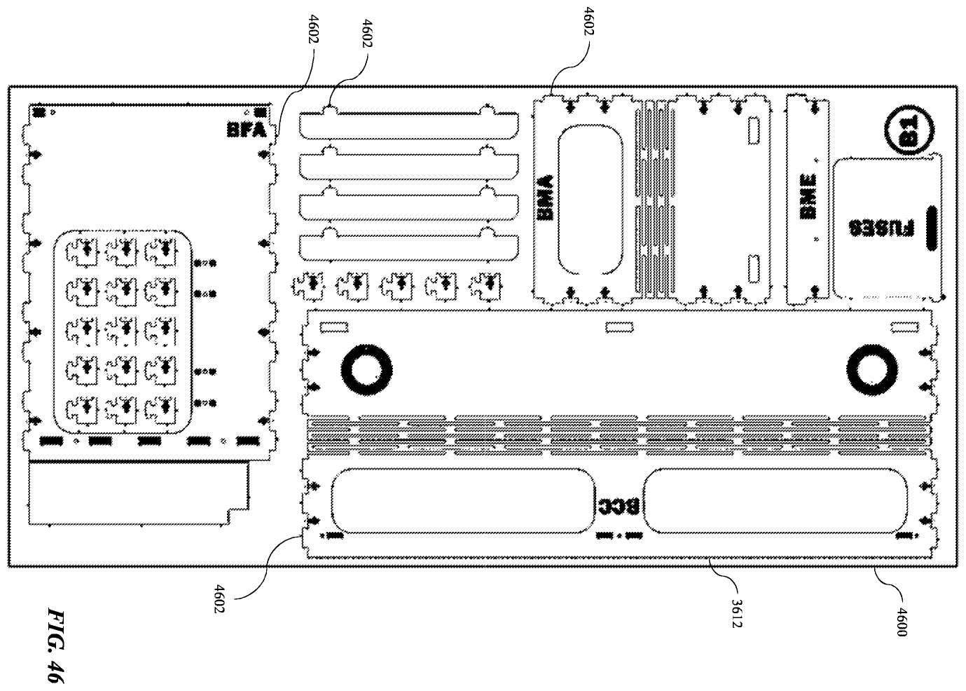

Referencing FIG. 46-50, one aspect of the invention concerns a method of manufacturing and facilitate the shipping of a van conversion kit. In one embodiment, sheet of material 4600 can be provided. A suitable material sheet 4600 can be made of, for example, wood or wood-derived products (such as plywood). In some embodiments, material sheet 4600 can be, for example, a standard sheet of plywood (such as 4-foot by 8-foot sheet, or a 5-foot by 5-foot sheet) having a thickness of, for example, ⅛-inch, ¼-inch, ⅜-in, ½-inch; ⅝-inch; and ¾-inch.

In certain embodiments, components of the van conversion kit are cut into sheet of material 4600. For example, overhead cabinet 3612 can be laser cut into sheet of material 4600. Similarly, other components such as pantry drawer door 4700 can be cut into sheet of material 4600. To facilitate shipping, tabs 4602 can be left in sheet of material 4600 to retain the van conversion component in sheet of material 4600 while shipping. This method of manufacturing components of the van conversion kit allows for use of a flat-pack shipping method, which can reduce shipping cost significantly when compare to conventional methods of manufacturing and shipping a vehicle conversion kit.

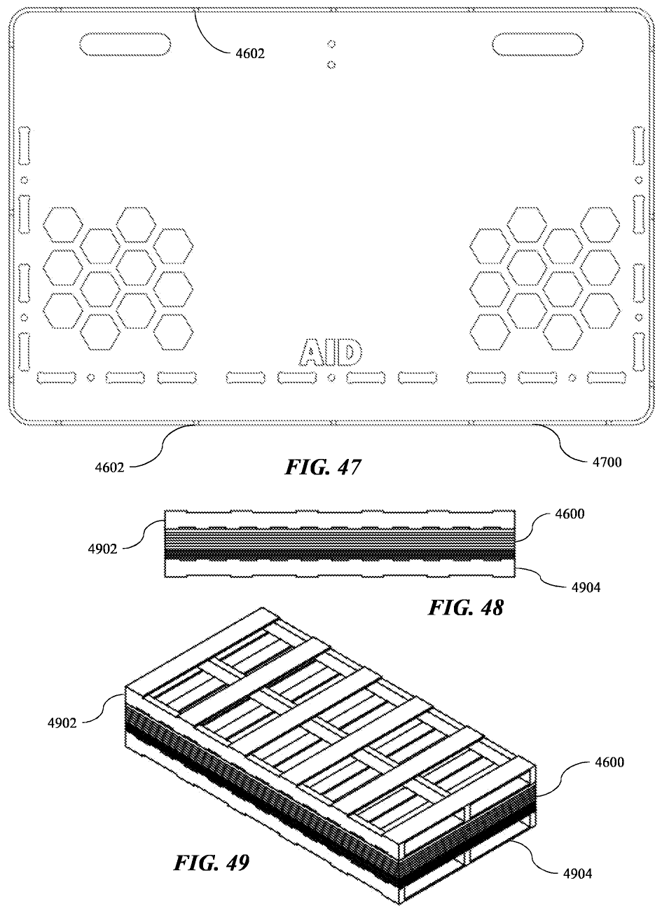

Referencing FIG. 48-50, in one embodiment, a van conversion kit (or substantial modules thereof, such as kitchen module 4418, bed module 3600, and/or CTS module 3900) can be cut into multiple material sheets 4600. The sheets of material 4600 can be stacked on top of one another with minimal packaging. In some embodiments, a shipment can include pallet 4902 placed above and pallet 4904 placed below the stacked sheets of material 4600. This shipping configuration facilitates the van conversion kit to be flat pack shipped and double stacked with minimal packaging. The sheets of material 4600 in this configuration are able to handle the load of an additional shipment stacked on top rather than require additional packaging to transfer the load around the product. The pallets 4902 and 4904, and stacking method, allow for a more rigid structure that makes forklift handling safer and easier. This shipping method facilitates drivers to manipulate the pallet with pallet jacks and does not require specialized handling equipment.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

1. A floor comprising:
a first floor section having a first side, the first side having alternating first tabs and first notches;
a second floor section having a second side, the second side having alternating second tabs and second notches;
wherein the first tabs are configured to interlock with the second notches, wherein the first notches are configured to interlock with the second tabs;
a first bolt;
a second bolt;
a first bolt hole in the first floor section configured to receive the first bolt;
a second bolt hole in the second floor section configured to receive the second bolt;
a first insert configured to fit in the first bolt hole, the first insert further configured to receive the first bolt, the first insert having a first flange;
a second insert configured to fit in the second bolt hole, the second insert further configured to receive the second bolt, the second insert having a second flange;
a first washer retained between the first flange and the first floor section and the second floor section, wherein a surface of the first washer overlaps between the first floor section and the second floor section; and
a second washer retained between the second flange and the first floor section and the second floor section, wherein a surface of the second washer overlaps between the first floor section and the second floor section.

2. The floor of claim 1, wherein the first bolt hole is placed substantially in the middle of a first tab of the first floor section, and wherein the second bolt hole is placed substantially in the middle of a second tab of the second floor section.

3. The floor of claim 1, wherein the first bolt hole is placed substantially in a corner of a first tab of the first floor section, and wherein the second bolt hole is placed substantially in corner of a second tab of the second floor section.

4. The floor of claim 1, wherein the first floor section is made of a wood-related material.

5. The floor of claim 1, wherein the first floor section is laser cut from a sheet of plywood.

6. The floor of claim 1, wherein the first floor section and the second floor section are configured for use as part of the flooring of a vehicle.

7. A flooring system for a vehicle, the flooring system comprising:
a first flooring section having first tabs and first notches;
a second flooring section having second tabs and second notches;
wherein the first tabs are configured to match and fit into the notches and the second tabs are configured to match and fit into the first notches; and
a plurality of clamps configured to clamp the first floor section to the second floor section by, at least in part, a component of each of the clamps overlapping a joint of each tab and notch pair formed by matching first tabs and second notches and matching second tabs and first notches.

8. The flooring system of claim 7, wherein the first tabs and second tabs have a generally trapezoidal shape.

9. The flooring system of claim 7, wherein the first tabs and second tabs have a generally rectangular shape with s-curved ends.

10. The flooring system of claim 7, wherein at least some of the plurality of clamps comprise a bolt and nut.

11. The flooring system of claim 10, wherein said at least some of the plurality of clamps further comprise a washer.

12. A method of installing a flooring of a vehicle, the method comprising:
providing a first flooring section having first tabs, first notches, first bolt holes in the first tabs, and first nut inserts installed in the first bolt holes;
providing a second flooring section having second tabs, second notches, second bolt holes in the second tabs, and second nut inserts in the second bolt holes;
placing the first flooring section on the floor of the vehicle and placing the second flooring section on the floor of the vehicle matching the first tabs with the second notches and the second tabs with the first notches;
placing first bolts into the first bolt holes and threading the first bolts into the first nut inserts to clamp the first flooring section to the second flooring section; and
placing second bolts into the second bolt holes and threading the second bolts into the second nut inserts to clamp the first flooring section to the second flooring section.

13. The method of claim 12, wherein the first tabs have a generally trapezoidal shape.

14. The method of claim 12, further comprising placing washers between the first nut inserts and the first flooring section and the second flooring section, the washers positioned to overlap a joint between the first flooring section and the second flooring section.

15. The method of claim 12, further comprising providing a floor bracket configured to clamp the first flooring section or the second flooring section to a fixture of the vehicle.

16. The method of claim 15, wherein the floor bracket comprises a bracket body having at least a first bracket bolt hole and a second bracket bolt hole, and wherein the first bracket bolt hole has a central axis that is orthogonal to a central axis of the second bolt hole.

17. The method of claim 16, further comprising placing a first bracket bolt into the first bracket bolt hole and threading the first bracket bolt into a first bracket nut insert provided in the first floor section, and further comprising placing a second bracket bolt into the second bracket bolt hole and threading the second bracket bolt into the fixture of the vehicle.

18. The method of claim 17, wherein the fixture of the vehicle is a vehicle wall or a bracket or rail attached to the vehicle wall.

19. The method of claim 17, wherein the floor bracket further comprises a third bracket bolt hole, the third bracket bolt hole having a main axis parallel to the first bracket bolt hole.

20. The method of claim 19, further comprising further comprising placing a third bracket bolt into the third bracket bolt hole and threading the third bracket bolt into a second bracket nut insert provided in the first floor section.
